(19) United States
(12) Patent Application Publication
(10) Pub. No.: US 2011/0250027 A1
(43) Pub. Date: Oct. 13, 2011

(54) DRILLING MACHINE

(76) Inventor: Shun Sheng Lin, Taichung City (TW)

(21) Appl. No.: 13/167,978

(22) Filed: Jun. 24, 2011

(30) Foreign Application Priority Data
Jun. 13, 2001 (TW) 100120577

(51) Int. Cl. B23B 47/06

(52) U.S. Cl. 408/129

(57) ABSTRACT

A drilling machine includes a stand unit, a drilling spindle unit, and a drive motor unit. A power control member controls a drive motor of the drive motor unit so as to control the rotational speed of the drive motor. A driving shaft of the drive motor drives a driving shaft sleeve of the drilling spindle unit to bring a working spindle in the driving shaft sleeve. The rotational speed of the drive motor is controlled by the power control member only. The present invention has a simple and endurable configuration, and is convenient for use and has stable configuration.

### BACKGROUND OF THE INVENTION

1. Field of the Invention

The present invention relates to a drilling machine.

2. Description of the Prior Art

As shown in FIG. 7, a conventional drilling machine comprises a stand unit (10), a working spindle control unit (40) and a transmission unit (50). The stand unit (10) comprises a base (11), a displacement adjustment shaft (12) on the base (11), and a worktable (13) which can be moved up and down along the displacement adjustment shaft (12). The working spindle control unit (40) is disposed above the displacement adjustment shaft (12) of the stand unit (10). The working spindle control unit (40) comprises a working spindle (41) and a feed control member (42). The transmission unit (50) is disposed on top of the displacement adjustment shaft (12). The transmission unit (50) comprises a motor (51), pulleys (52), and a driving belt (53). The motor (51) drives the pulleys (52) and the driving belt (53), and the pulleys (52) link the working spindle (41) of the working spindle control unit (40). The rotational speed of feed is adjusted by the pulleys (52) and the driving belt (53). However, there are some problems existing in the conventional drilling machine.

1. Inconvenient Use: The motor drives the pulleys and the driving belt. The pulleys link the working spindle of the working spindle control unit. It is necessary to adjust the pulleys and the driving belt of the transmission unit when the adjustment of the rotational speed of feed is required. This is not convenient for use.

2. Unstable configuration: The motor drives the pulleys and the driving belt. The pulleys link the working spindle of the working spindle control unit. It is necessary to adjust the pulleys and the driving belt of the transmission unit when the adjustment of the rotational speed of feed is required. The belt easily breaks and needs replacement to influence the work efficiency, so its configuration is unstable.

Accordingly, the inventor of the present invention has devoted himself based on his many years of practical experiences to solve these problems.

### SUMMARY OF THE INVENTION

The primary object of the present invention is to provide a drilling machine which can overcome the problems existing is the prior art.

The drilling machine of the present invention comprises a stand unit, a drilling spindle unit, and a drive motor unit. The stand unit comprising a base, a displacement adjustment shaft on the base, a worktable which is moved up and down along the displacement adjustment shaft, and a working spindle control seat which is disposed at an upper end of the displacement adjustment shaft. The working spindle control seat has an insertion hole and a displacement control rotary member. A power control member is provided on an outer side of the working spindle control seat. The drilling spindle unit comprises a displacement control spindle sleeve and a driving shaft sleeve. The displacement control spindle sleeve comprises a working spindle. One end of the working spindle is provided with a link shaft, and another end of the working spindle is provided with a drilling clamp seat. The driving shaft sleeve has a positioning hole at one end thereof and an engaging hole at another end thereof. The positioning hole of the driving shaft sleeve is engaged with the link shaft of the displacement control spindle sleeve. The drive motor unit comprises a drive motor and a hollow motor seat. The drive motor includes a driving shaft. The drive motor unit is disposed on top of the working spindle control seat. The driving shaft of the drive motor is inserted in and engaged with the engaging hole of the driving shaft sleeve of the drilling spindle unit. The drive motor is electrically connected to the power control member of the stand unit.

The drive motor unit is disposed on top of the working spindle control seat of the stand unit. The second locking holes of the hollow motor seat are aligned with the coupling holes of the working spindle control seat, and the locking members of the drive motor are screwed to the coupling holes. The driving shaft of the drive motor is inserted in and engaged with the engaging hole of the driving shaft sleeve of the drilling spindle unit. The drive motor is electrically connected to the power control member of the stand unit. The power control member controls the drive motor of the drive motor unit so as to control the rotational speed of the drive motor. The driving shaft of the drive motor drives the driving shaft sleeve of the drilling spindle unit to bring the working spindle in the driving shaft sleeve. The rotational speed of the drive motor is controlled by the power control member only. The entire configuration of the present invention is simple and endurable, which is convenient for use and has stable configuration.

### BRIEF DESCRIPTION OF THE DRAWINGS

FIG. 1 is a perspective view according to a preferred embodiment of the present invention;

FIG. 2 is an exploded view according to the preferred embodiment of the present invention;

FIG. 3 is a partial exploded view showing the drilling spindle unit and the drive motor unit according to the preferred embodiment of the present invention;

FIG. 4 is a partial sectional view according to the preferred embodiment of the present invention;

FIG. 5 is a partial front view according to the preferred embodiment of the present invention in an operating state;

FIG. 6 is an exploded view showing another embodiment of the driving shaft sleeve of the present invention; and

FIG. 7 is a perspective view of a conventional drilling machine.

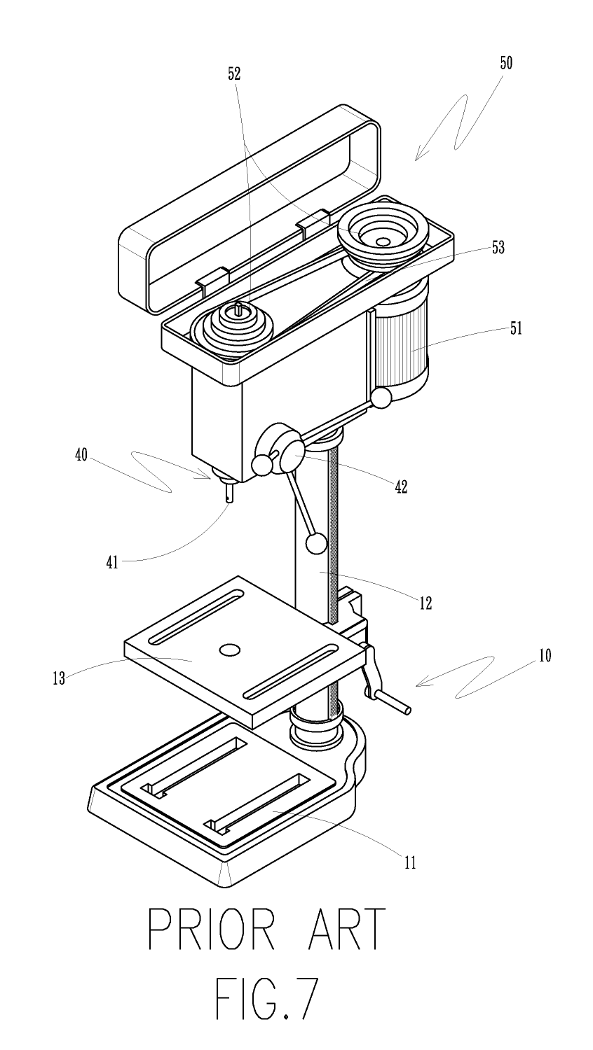

### DETAILED DESCRIPTION OF THE PREFERRED EMBODIMENTS

Embodiments of the present invention will now be described, by way of example only, with reference to the accompanying drawings.

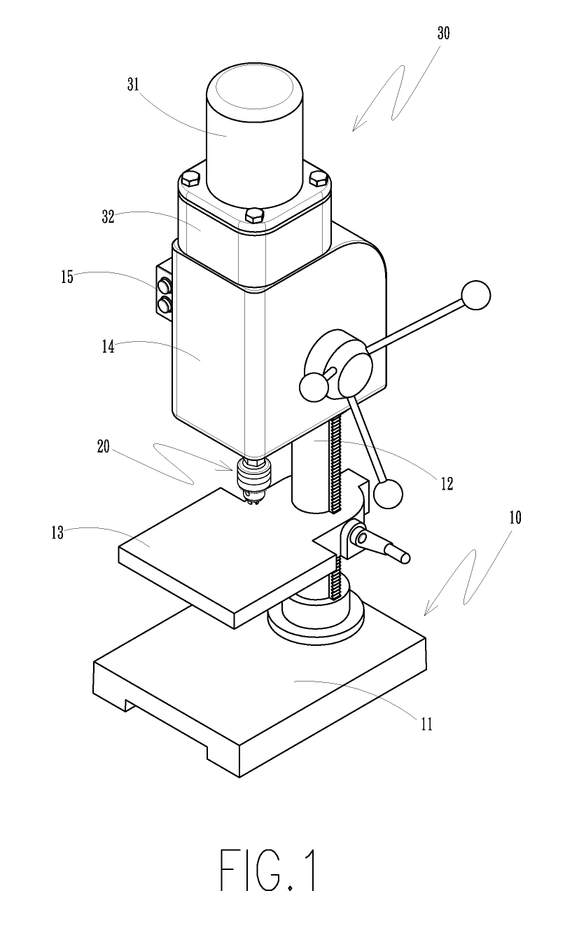

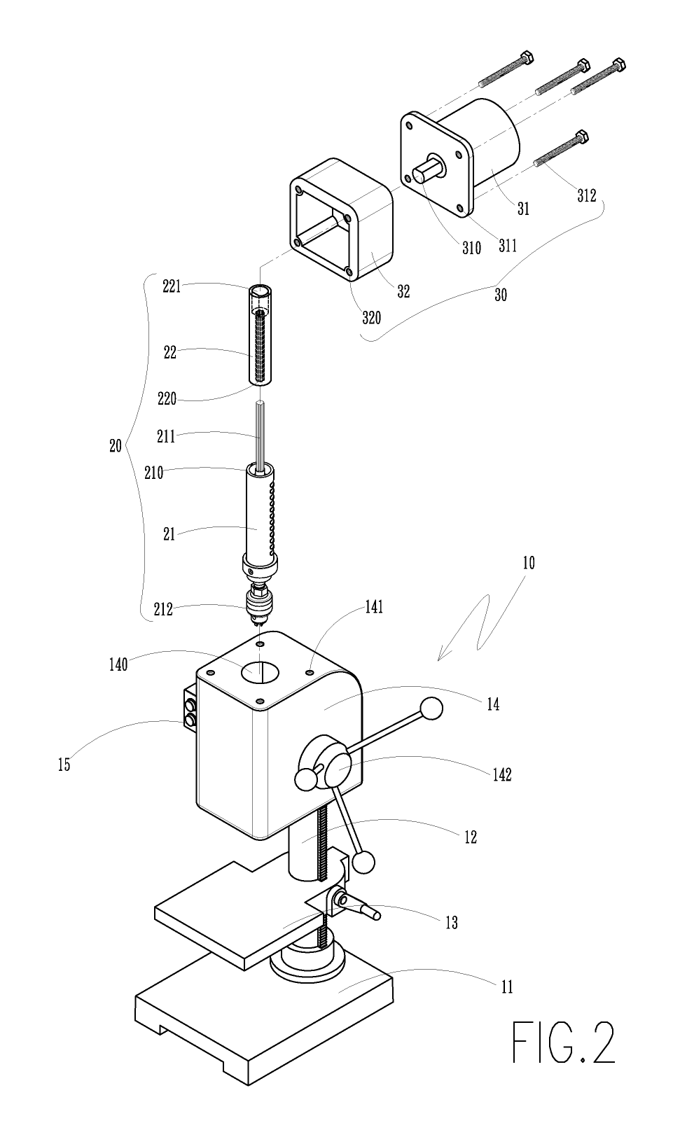

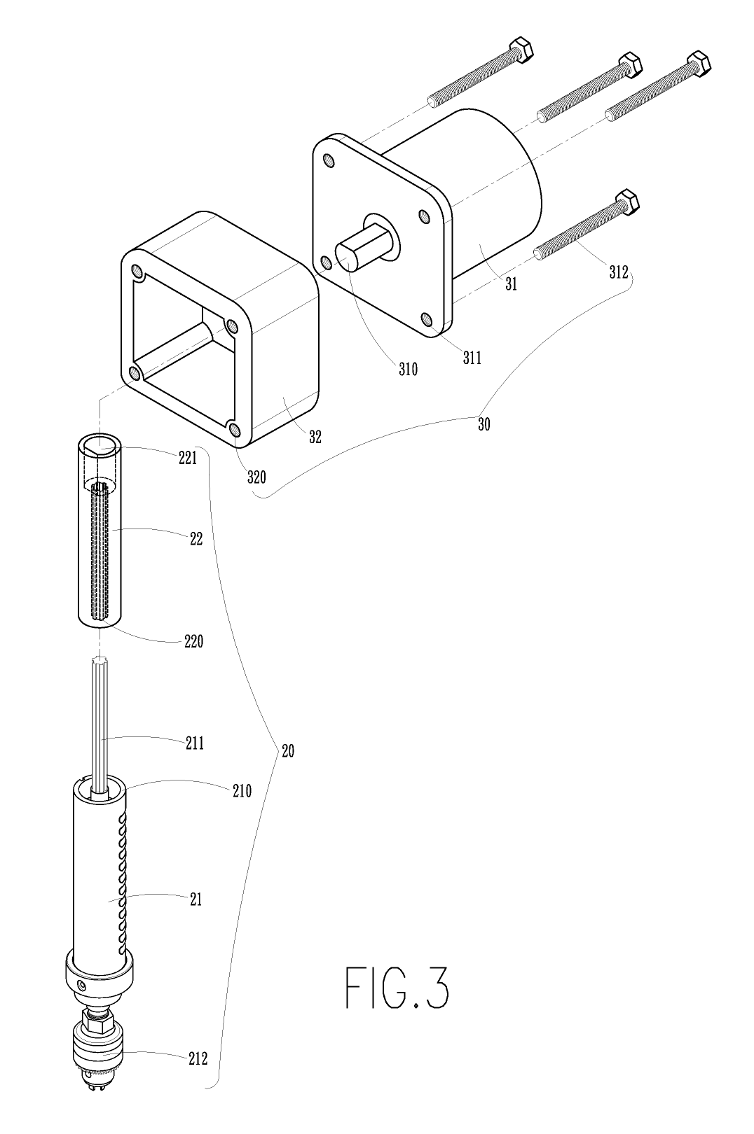

As shown in FIG. 1 through FIG. 4, the drilling machine according to a preferred embodiment of the present invention comprises a stand unit (10), a drilling spindle unit (20), and a drive motor unit (30).

The stand unit (10) comprises a base (11), a displacement adjustment shaft (12) on the base (11), a worktable (13) which can be moved up and down along the displacement adjustment shaft (12), and a working spindle control seat (14) which is disposed on at upper end of the displacement adjustment shaft (12). The working spindle control seat (14) has an insertion hole (140), a plurality of coupling holes (141), and a displacement control rotary member (142). A power control member (15) is provided on an outer side of the working spindle control seat (14).

The drilling spindle unit (20) comprises a displacement control spindle sleeve (21) and a driving shaft sleeve (22). The displacement control spindle sleeve (21) comprises a working spindle (210). One end of the working spindle (210) is provided with a link shaft (211), and another end of the working spindle (210) is provided with a drilling clamp seat (212). The driving shaft sleeve (22) has a positioning hole (220) at one end thereof and an engaging hole (221) at another end thereof. The positioning hole (220) of the driving shaft sleeve (22) is engaged with the link shaft (211) of the displacement control spindle sleeve (21).

The drive motor unit (30) comprises a drive motor (31) and a hollow motor seat (32). The drive motor (31) is an adjustable speed motor. The drive motor (31) includes a driving shaft (310) and a plurality of first locking holes (311) for insertion of locking embers (312). The hollow motor seat (32) has a plurality of second locking holes (320) corresponding to the first locking holes (311) of the drive motor (31). The drive motor (31) is coupled to the hollow motor seat (32). The locking members (312) are inserted through the first locking holes (311) of the drive motor (31) and the second locking holes (320) of the hollow motor seat (32). The drive motor unit (30) is disposed on top of the working spindle control seat (14). The second locking holes (320) of the hollow motor seat (32) are aligned with the coupling holes (141) of the working spindle control seat (14), and the locking members (312) of the drive motor (31) are screwed to the coupling holes (141). The driving shaft (310) of the drive motor (31) is inserted in and engaged with the engaging hole (221) of the driving shaft sleeve (22) of the drilling spindle unit (20). The drive motor (31) is electrically connected to the power control member (15) of the stand unit (10). Thus, the drilling machine of the present invention is completed.

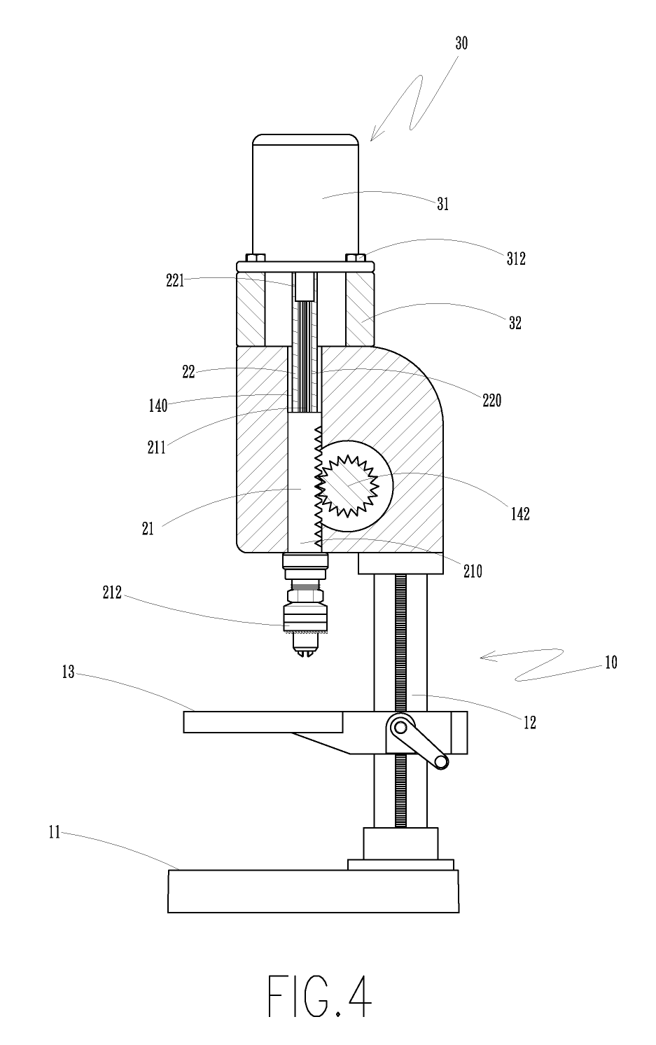

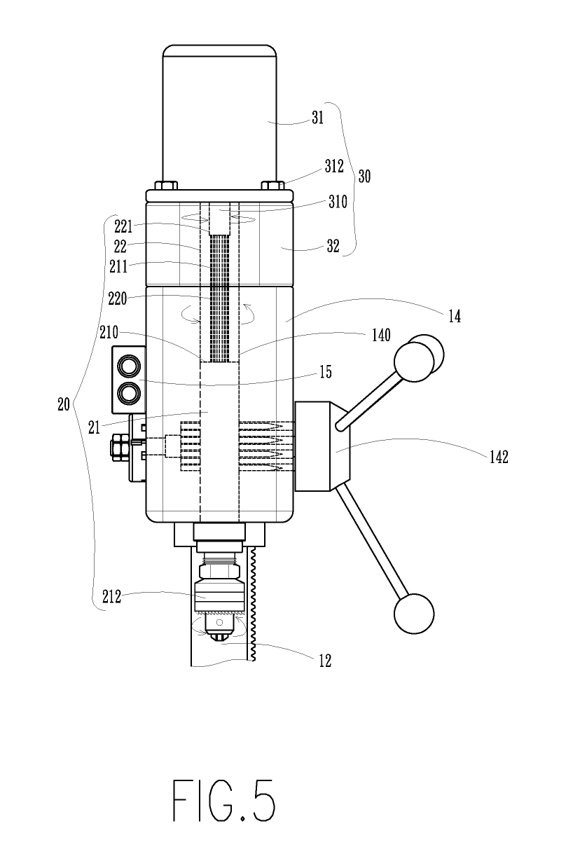

FIG. 4 is a partial sectional view according to the preferred embodiment of the present invention. FIG. 5 is a partial front view according to the preferred embodiment of the present invention in an operating state. The drive motor unit (30) is disposed on top of the working spindle control seat (14) of the stand unit (10). The second locking holes (320) of the hollow motor seat (32) are aligned with the coupling holes (141) of the working spindle control seat (14), and the locking members (312) of the drive motor (31) are screwed to the coupling holes (141). The driving shaft (310) of the drive motor (31) is inserted in and engaged with the engaging hole (221) of the driving shaft sleeve (22) of the drilling spindle unit (20). The drive motor (31) is electrically connected to the power control member (15) of the stand unit (10). The drive motor (31) of the drive motor unit (30) is electrically connected to the power control member (15) of the stand unit (10). The power control member (15) controls the drive motor (31) of the drive motor unit (30) so as to control the rotational speed of the drive motor (31). The driving shaft (310) of the drive motor (31) drives the driving shaft sleeve (22) of the drilling spindle unit (20) to bring the working spindle (210) in the driving shaft sleeve (22). The rotational speed of the drive motor (31) is controlled by the power control member (15) only. The entire configuration of the present invention is simple and endurable, which is convenient for use and has stable configuration.

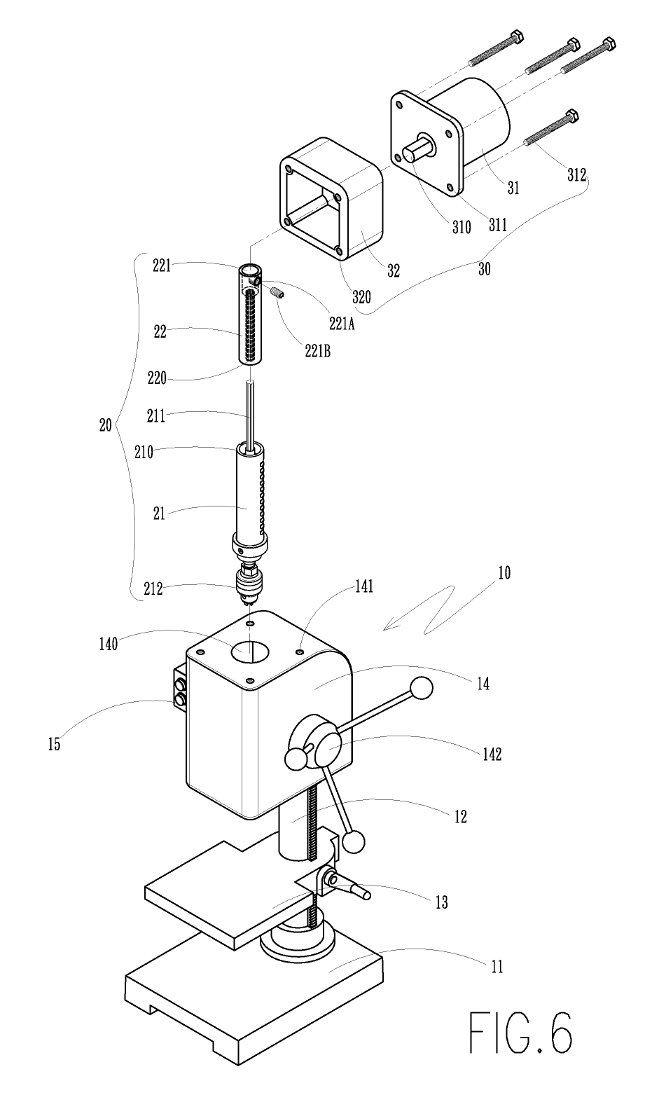

FIG. 6 is an exploded view showing another embodiment of the driving shaft sleeve of the present invention, which is substantially similar to the embodiment as shown in FIG. 1 through FIG. 4 with the exceptions described hereinafter. The driving shaft sleeve (22) of the drilling spindle unit (20) has a fastening hole (221A) at an outer side of the engaging hole (221) for insertion of a fastening member (221B). The driving shaft (310) of the drive motor unit (30) is inserted in the engaging hole (221) of the driving shaft sleeve (22) and fastened by the fastening member (221B) which is inserted through the fastening hole (221A), so that the driving shaft (310) of the drive motor unit (30) is steady engaged in the engaging hole (221) of the driving shaft sleeve (22).

The present invention has the following advantages:

1. Convenient use: The power control member controls the drive motor of the drive motor unit so as to control the rotational speed of the drive motor. The driving shaft of the drive motor drives the driving shaft sleeve of the drilling spindle unit to bring the working spindle in the driving shaft sleeve. The rotational speed of the drive motor is controlled by the power control member only. This is very convenient for use.

2. Stable configuration: The power control member controls the drive motor of the drive motor unit so as to control the rotational speed of the drive motor. The driving shaft of the drive motor drives the driving shaft sleeve of the drilling spindle unit to bring the working spindle in the driving shaft sleeve. The rotational speed of the drive motor is controlled by the power control member only, not driven by the transmission unit. The configuration of the present invention is simple and stable.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A drilling machine, comprising:
a stand unit, the stand unit comprising a base, a displacement adjustment shaft on the base, a worktable which is moved up and down along the displacement adjustment shaft and a working spindle control seat which is disposed at an upper end of the displacement adjustment shaft, the working spindle control seat having an insertion hole and a displacement control rotary member, a power control member provided on an outer side of the working spindle control seat;
a drilling spindle unit, the drilling spindle unit comprising a displacement control spindle sleeve and a driving shaft sleeve, the displacement control spindle sleeve comprising a working spindle, one end of the working spindle being provided with a link shaft and another end of the working spindle being provided with a drilling clamp seat, the driving shaft sleeve having a positioning hole at one end thereof and an engaging hole at another end thereof, the positioning hole of the driving shaft sleeve being engaged with the link shaft of the displacement control spindle sleeve; and
a drive motor unit, the drive motor unit comprising a drive motor and a hollow motor seat, the drive motor including a driving shaft, the drive motor unit being disposed on top of the working spindle control seat, the driving shaft of the drive motor being inserted in and engaged with the engaging hole of the driving shaft sleeve of the drilling spindle unit, the drive motor being electrically connected to the power control member of the stand unit.

2. The drilling machine as claimed in claim 1, wherein the working spindle control seat has a plurality of coupling holes, the drive motor including a plurality of first locking holes for insertion of locking embers, the hollow motor seat having a plurality of second locking members corresponding to the first locking holes of the drive motor, the drive motor being coupled to the hollow motor seat, the locking members being inserted through the first locking holes of the drive motor and the second locking holes of the hollow motor seat, the second locking holes of the hollow motor seat being aligned with the coupling holes of the working spindle control seat, the locking members of the drive motor being screwed to the coupling holes.

3. The drilling machine as claimed in claim 1, wherein the driving shaft sleeve of the drilling spindle unit has a fastening hole at an outer side of the engaging hole for insertion of a fastening member, the driving shaft of the drive motor unit being inserted in the engaging hole of the driving shaft sleeve and fastened by the fastening member inserted through the fastening hole.

4. The drilling machine as claimed in claim 1, wherein the drive motor is an adjustable speed motor.
